(19) United States
(12) Patent Application Publication
(10) Pub. No.: US 2018/0361300 A1
(43) Pub. Date: Dec. 20, 2018

(54) Filter Bellows and Filter Element

(71) Applicant: MANN+HUMMEL GmbH, Ludwigsburg (DE)

(72) Inventors: Markus Roehrig, Landshut (DE); Markus Schmidl, Pilsting (DE); Timo Dirnberger, Marbach (DE); Daniel Schmid, Sachsenheim (DE); Sven Epli, Heilbronn (DE)

(21) Appl. No.: 16/007,328

(22) Filed: Jun. 13, 2018

Related U.S. Application Data
(63) Continuation of application No. PCT/EP2016/078846, filed on Nov. 25, 2016.

(30) Foreign Application Priority Data
Dec. 16, 2015 (DE) 10 2015 016 237.3

(51) Int. Cl. B01D 46/52; B01D 46/10

(52) U.S. Cl. CPC B01D 46/521; B01D 46/10; B01D 2279/60; B01D 2265/026; B01D 2275/205

(57) ABSTRACT

A filter bellows with zigzag-folded filter medium has first and second fold edges extending between opposite end edge faces of the filter medium. The filter bellows has opposite end faces with an end fold. The filter bellows in use has a raw fluid-side surface and a clean fluid-side surface. First fold edges are positioned at the raw fluid-side surface and second fold edges are positioned at the clean fluid-side surface. The filter bellows has a passage extending between raw fluid-side surface and clean fluid-side surface. The passage has a first opening at the raw fluid-side surface provided with a first cross section and a second opening at the clean fluid-side surface provided with a second cross section. When projecting the first and second openings onto each other, one cross section, at least with sections thereof, is arranged outside of the other cross section.

### CROSS-REFERENCE TO RELATED APPLICATIONS

This application is a continuation application of international application No. PCT/EP2016/078846 having an international filing date of 25 Nov. 2016 and designating the United States, the international application claiming a priority date of 16 Dec. 2015 based on prior filed German patent application No. 10 2015 016 237.3, the entire contents of the aforesaid international application and the aforesaid German patent application being incorporated herein by reference.

### BACKGROUND OF THE INVENTION

The invention concerns a filter bellows of a filter medium folded in a zigzag shape, as well as a filter element and a filter system, in particular for use as a flat air filter of an internal combustion engine, in particular of a motor vehicle.

End folds are the two outer folds at oppositely positioned end faces of the filter bellows of a filter element. End fold rims are the two free rims of the filter medium of which the filter bellows is formed and which extend along the end folds and delimit them at the end faces of the filter bellows. End edges of the filter bellows are the two other free rims of the filter bellows which extend between the end fold rims and are extending in accordance with the folding of the filter bellows. The fold edges are the edges along which the filter medium is folded. In case of an approximately parallelepipedal filter bellows folded in a zigzag shape and known on the market, the end fold rims and the fold edges are in general straight and extend parallel to each other. The end edges extend, viewed from the side looking onto the filter bellows, in a zigzag shape and perpendicular to the end fold rims and the fold edges. Prior to folding the filter medium, the end edges of the filter bellows, which later on will exhibit an imaginary parallelepipedal envelope, extend straight and parallel to each other. The imaginary envelope is defined by the end edges, the fold edges and end fold rims neighboring each other at a clean fluid side of the filter bellows, and the fold edges and end fold rims neighboring each other at a raw fluid side.

In case of filter bellows of flat filter elements, the filter media are not closed, i.e., the end folds, like the end edges, are not connected to each other. In contrast to this, in filter bellows of round filter elements the filter media are closed, i.e., their end folds are connected to each other. Filter bellows of flat filter elements in this context can be planar but can also comprises bends in different directions.

The prior art encompasses rectangular or trapezoidal filter bellows for flat filter elements or filter bellows with cut-off corners which are manufactured from an endlessly extending web of a filter medium. By laser cutting, for example, a plurality of geometries are conceivable which however entail partially a significant paper loss and thus waste of filter medium.

EP 1144083 B1 discloses a filter element in which a support passes through a passage in the filter element. In particular in case of a housing which is suitable for receiving flat filter elements, this constitutes a support between the oppositely positioned center points of the housing shells. These points are those with the greatest vibration amplitude in case of a component vibration. In this way, a reinforcement effect can be obtained by providing only one support. The passage is sealed off completely relative to the support by providing an additional seal so that a filter function without air leak can be ensured. The passage which is provided in this filter element is rectangular. It is oriented such that two of the oppositely positioned rectangle edges which are referred to as transverse edges extend parallel to the fold edges. The edges are formed by the fold edges themselves. Such a passage is introduced by waterjet cutting or by laser beam cutting into the already folded filter medium.

### SUMMARY OF THE INVENTION

An object of the invention is to provide an areal filter bellows which enables stable installation in the housing of a filter system.

According to an aspect of the invention, the aforementioned object is solved by a filter bellows, in particular for an air filter system, of a filter medium folded in a zigzag shape, wherein a passage between a raw fluid-side surface and a clean fluid-side surface is formed with a raw fluid-side opening with raw fluid-side cross section and a clean fluid-side opening with a clean fluid-side cross section, wherein, in a projection of the openings onto each other, one of the cross sections, at least with sections thereof, is arranged outside of the other one of the cross sections.

Beneficial embodiments and advantages of the invention result from the additional claims, the description, and the drawing.

A filter bellows, in particular for an air filter system, of a filter medium folded in a zigzag shape is proposed, wherein fold edges extend respectively between oppositely positioned end edge faces formed of end edges, and wherein an end fold with a fold edge and an oppositely positioned free end fold rim is arranged at oppositely positioned end faces, respectively, and fold edges are positioned at a raw fluid-side surface in the installed state of use and at an oppositely positioned clean fluid-side surface in the installed state of use. In this context, a passage between the raw fluid-side surface and the clean fluid-side surface is formed with a raw fluid-side opening with a raw fluid-side cross section and a clean fluid-side opening with a clean fluid-side cross section, wherein, in a projection of the openings onto each other, one of the cross sections, at least with sections thereof, is arranged outside of the other one of the cross sections.

The filter bellows is in particular embodied as an areal filter bellows, also referred to as flat filter bellows. In case of a flat filter bellows, the fold edges are embodied straight and are producible, for example, by knife pleating or rotary pleating methods. Moreover, a flat filter bellows is not annularly closed, in contrast to a round filter bellows whose fold edges form annularly closed inflow and outflow surfaces, respectively, that can be flowed through radially.

According to the invention, the filter bellows, which can be embodied in particular as an areal filter bellows of a flat air filter, is provided with a passage that provides a continuous channel between the raw fluid-side surface and the clean fluid-side surface. This passage can be guided perpendicular to one of the surfaces through the filter bellows, but the passage can also be embodied to extend through the filter bellows at a slant relative to one of the two surfaces or to both surfaces. In this context, the raw fluid-side opening of the passage and the clean fluid-side opening can be of identical design. In the simplest case, both are of a circular shape so that a cylinder-shaped passage through the filter bellows is produced. The cross sections of the raw fluid-side opening and of the clean fluid-side opening however can also be embodied to have an oval, elliptical or angular shape or a mixed form thereof. Also, the raw fluid-side cross section and the clean fluid-side cross section can be differently configured, for example, one cross section can be round and the other cross section oval or angular. The passage can thus realize a transition from the raw fluid-side cross section to the clean fluid-side cross section. Also, one of the two cross sections can be larger than the other cross section so that a funnel-shaped passage is produced.

An advantage of a configuration of the raw fluid-side cross section and of the clean fluid-side cross section in different shapes resides in that, by means of a so-called poka-yoke effect, an improper installation of the filter bellows in the filter system is avoided. Also, a simpler installation in an adapted filter housing of the filter system can be achieved in this way.

According to an advantageous embodiment, the passage passes through the filter bellows from the raw fluid side to the clean fluid side. This means that the passage interrupts at least one raw fluid-side fold edge in the region of its raw fluid-side opening and interrupts at least one clean fluid-side fold edge in the region of its clean fluid-side opening. Preferably, in the region of the passage and its openings, at both sides a plurality of adjacently positioned folds and thus also adjacently positioned fold edges are interrupted at both sides.

According to an advantageous embodiment, the raw fluid-side opening in respect to its contour can be embodied to be different from the contour of the clean fluid-side opening. For example, one of the two openings can be embodied round or oval and the other one of the two openings can be embodied angular. In this way, a poka-yoke effect is advantageously achieved which enables an unambiguous installation of the filter bellows in a filter system. Also, the counter elements in the housing of the filter system can be correspondingly designed in a beneficial way for mounting.

According to an advantageous embodiment, the passage, at least in a section thereof, can have a conical extension between the raw fluid-side opening and the clean fluid-side opening. Such a conical extension which may be realized in that one of the two openings is larger than the other one, benefits the installation of the filter bellows, for example, by a facilitated insertion of a mounting element through the filter bellows in order to fasten the latter in a filter housing. In this way, an improved force introduction during installation in the filter housing is possible because a support of the mounting element can be designed stiffer. Mounting tolerances therefore play a less important role. Also, such an insertion aid which is beneficial for mounting the filter bellows can be realized in an advantageous way.

According to an advantageous embodiment, the passage can comprise, at least in a section thereof, a stepped extension of its wall. For example, for manufacturing technological reasons, it can be beneficial when the passage is embodied in a stepped shape. For example, in this way the filter bellows can be bored from the raw fluid-side surface to a certain depth of the filter bellows with a different cross section than from the surface at the clean fluid side. In this way, two partial passages with different cross sections then meet each other so that, as a whole, a stepped extension of the passage is provided. It can be beneficial in this context, for example, for reasons of manufacturing tolerances, that one of the cross sections in this context is greater than the other cross section

According to an advantageous embodiment, at least one of the end edge faces and/or one of the end faces can be subjected to a directional change. In such a configuration of the filter bellows, which deviates from a simple parallelepipedal shape, installation space specifications can be utilized beneficially because such a filter bellows can be virtually fitted to complex installation spaces. For example, in this way a parallelepipedal part of a filter bellows can be combined with a triangular or semi-circular part of a filter bellows.

According to an advantageous embodiment, the passage can be formed by laser cutting of the filter medium. By laser cutting, complex shape specifications can be fulfilled in a beneficial and inexpensive way. Also, by laser cutting the filter medium is affected only minimally because laser cutting represents a very gentle cutting method with which almost no mechanical pressure is applied onto the filter medium. Also, in this way advantageously slanted passages in pre-manufactured folded filter bellows can be introduced in a beneficial way because the geometry can be adjusted very flexibly by means of laser cutting.

According to an advantageous embodiment, the filter medium can comprise cellulose and/or can be made of cellulose. As filter media, beneficially nonwovens are employed. For this purpose, cellulose is useable in a very flexible way and is also of great advantage with regard to environmental concerns due to its easy degradability.

According to a further aspect, the invention concerns a filter element for filtering a fluid, with a filter bellows of a filter medium folded in a zigzag shape, wherein fold edges extend respectively between oppositely positioned end edge faces formed of end edges, and wherein an end fold with a fold edge and an oppositely positioned free end fold rim is arranged at oppositely positioned end faces, respectively, and fold edges are positioned at a raw fluid-side surface in the installed state of use and an oppositely positioned clean fluid-side surface in the installed state of use. In this context, a passage between the raw fluid-side surface and the clean fluid-side surface is formed with a raw fluid-side opening with a raw fluid-side cross section and a clean fluid-side opening with a clean fluid-side cross section, wherein, in a projection of the openings onto each other, at least one of the cross sections, at least with sections thereof, is arranged outside of the other one of the cross sections.

The filter element is in particular embodied as a flat filter element. In a flat filter element in accordance with the present invention, the fold edges of the filter bellows are embodied straight and are producible, for example, by knife pleating or rotary pleating methods. Moreover, a flat filter element is not annularly closed, in contrast to a round filter element in which fold edges of a round filter bellows form annularly closed inflow and outflow surfaces, respectively, that can be radially flowed through.

The afore described filter bellows can thus be used advantageously in a filter element that is exchangeably useable in a filter system. The filter bellows that is embodied in particular as an areal filter bellows of a flat air filter is provided with a passage that provides a continuous channel between the raw fluid-side surface and the clean fluid-side surface. This passage can extend perpendicular to one of the surfaces through the filter bellows but the passage can also be embodied to extend through the filter bellows at a slant relative to one of the two surfaces or to both surfaces. In this context, the raw fluid-side opening of the passage and the clean fluid-side opening can be of the same configuration. In the simplest case, the two are embodied circular so that a cylindrically shaped passage through the filter bellows is produced. The cross sections of the raw fluid-side opening and of the clean fluid-side opening can however also be embodied to have an oval, elliptical or angular shape or a mixed form thereof. Also, the raw fluid-side cross section and the clean fluid-side cross section can be differently configured, for example, one cross section round and the other cross section oval or angular. The passage can thus realize a transition from the raw fluid-side cross section to the clean fluid-side cross section. Also, one of the two cross sections can be larger than the other cross section so that a funnel-shaped passage is produced.

An advantage of an embodiment of the raw fluid-side cross section and the clean fluid-side cross section in different shapes resides in that an improper installation of the filter bellows in a filter system can be avoided due to a poka-yoke effect. Also, in this way a simpler installation in an adapted filter housing of the filter system can be achieved.

According to an advantageous embodiment, the filter bellows can comprise a circumferential seal at end edges and end fold rims of the raw fluid-side surface and/or of the clean fluid-side surface as well as at the raw fluid-side opening of the passage and/or of the clean fluid-side opening of the passage. In this way, an effective sealing action of the filter element when installed in a filter housing, and thus the separation between a raw fluid side and a clean fluid side of the filter system, is possible. The efficiency of a filter system depends substantially on a reliable separation of raw fluid side from the clean fluid side. Primarily, the sealing action in use in a motor vehicle must function under very different environmental conditions entailing great temperature fluctuations, moisture, vibrations and the like. Leakage of the filter system between the raw fluid side and the clean fluid side can thus be avoided quite reliably.

As a circumferential seal, a seal which is congruently foamed onto the filter bellows, for example, of a PUR foam, can therefore be provided particularly advantageously. In this way, it is possible to produce a connection as strong as possible between the filter bellows and the seal which is also substantially permanently seal-tight and in this way ensures the efficiency of the filter system at least for the service life of the filter element. As a material for the foamed-on seal, for example, polyurethane foams are conceivable which enable a very flexible shaping and, on the other hand, a strong and permanent connection. Also, the processing steps can be designed such that conventional filter media can be foamed about with them in a compatible way and no degradations at the interfaces between plastic material and filter medium can occur. In this way, also extensive design variations of the shape of the filter element can be achieved.

Advantageously, the circumferentially extending seal can be arranged at end edges and end fold rims of the filter bellows as well as at the raw fluid-side opening of the passage and/or at the clean fluid-side opening of the passage. In this way, it is possible to insert the filter element into the housing bottom part of a filter housing so that the raw fluid side of the filter element terminates with a housing edge and the housing top part can be placed on top. In this way, the raw fluid side of the filter element can be sealed beneficially from the clean fluid side of the filter element. Also, when exchanging the filter element, a contamination of the clean fluid side of the filter system can thus be avoided. According to an advantageous embodiment, at least one of the end edge faces and/or one of the end faces can be subjected to a directional change. In such an embodiment of the filter element, which deviates from a simple parallelepipedal shape, installation space specifications can be utilized beneficially because such a filter element can be essentially fitted into complex installation spaces. For example, in this context a parallelepipedal part of a filter bellows can be combined with a triangular or semi-circular part of a filter bellows to a filter element which is beneficial regarding the installation space.

According to a further aspect, the invention concerns the use of the filter system as a flat air filter, in particular as a flat air filter of an internal combustion engine, in particular of a motor vehicle. Conceivable is also the use for other flowing media, for example, oil, fuel, urea, and the like.

According to a further aspect, the invention concerns a filter system with a filter element wherein the filter element is exchangeably arranged in a filter housing that comprises at least a housing bottom part and a housing top part which are connected fluid-tightly and detachably to each other and wherein the filter element fluid-tightly separates a raw fluid side from a clean fluid side of the filter system. By use of a filter element with a filter bellows according to the invention with a passage that provides a raw fluid-side opening and a clean fluid-side opening, wherein the passage can extend at a slant relative to the raw fluid-side surface and/or to the clean fluid-side surfaces of the filter bellows, a reliable installation of the filter element in the filter housing can be ensured. An advantage of a configuration of the raw fluid-side cross section and the clean fluid-side cross section of the passage in particular in different shapes resides in that an improper installation of the filter bellows in a filter system can be avoided by means of a poka-yoke effect. Also, in this way a simpler installation in an adapted filter housing of the filter system can be achieved.

According to an advantageous embodiment, a reinforcement center support supported at the housing bottom part and/or housing top part can be arranged in the passage when the filter element is installed. This reinforcement center support, which can be realized, for example, as a tie bar in the filter housing, permits a reliable installation by means of an additional support of the filter bellows and thus of the filter element in its surface at the filter housing. In this way, also possible vibrations, which may occur, for example, in operation in a motor vehicle, can be kept away from the filter element. Vibrations of the filter bellows can thus be suppressed effectively, which favors a long service life of the filter element.

According to an advantageous embodiment, the passage can be embodied as a clean air outlet. By means of such a flow opening in the filter bellows of a filter system, the filtered fluid, for example, air, can be returned in a targeted fashion. Fluid inlets and outlets of the filter system can thus be designed in a flexible way. In particular by a slanted passage relative to one or both surfaces of the filter bellows, it is possible to beneficially design a flow guidance of the fluid to be filtered into a calm flow region of the filter system.

### BRIEF DESCRIPTION OF THE DRAWINGS

Further advantages result from the following drawing description. In the drawings, embodiments of the invention are illustrated. The drawings, the description, and the claims contain numerous features in combination. A person of skill in the art will also expediently consider the features individually and combine them to meaningful additional combinations.

FIG. 1 shows a plan view of a filter bellows according to an embodiment of the invention with a slanted passage.

FIG. 2 shows a cross section along the line II-II of the filter bellows of FIG. 1.

FIG. 3 is an isometric illustration of the filter bellows of FIG. 1.

FIG. 4 shows a plan view of a filter bellows according to another embodiment of the invention with a stepped passage.

FIG. 5 shows a cross section along the line V-V of the filter bellows of FIG. 4.

FIG. 6 is an isometric illustration of the filter bellows of FIG. 4.

FIG. 7 shows a plan view of a filter bellows according to a further embodiment of the invention with a passage that extends at a slant in a section thereof.

FIG. 8 shows a cross section along the line VII-VII of the filter bellows of FIG. 7.

FIG. 9 is an isometric illustration of the filter bellows of FIG. 7.

FIG. 10 shows a plan view of the filter bellows according to a further embodiment of the invention with a stepped passage extending at a slant.

FIG. 11 shows a cross section along the line XI-XI of the filter bellows of FIG. 10.

FIG. 12 is an isometric illustration of the filter bellows of FIG. 10.

FIG. 13 shows a plan view of a filter bellows according to a further embodiment of the invention with a passage that in a section thereof extends at a slant and conical.

FIG. 14 shows a cross section along the line XIV-XIV of the filter bellows of FIG. 13.

FIG. 15 is an isometric illustration of the filter bellows of FIG. 13.

FIG. 16 shows a plan view of a filter bellows according to a further embodiment of the invention with a passage that in a section thereof extends conically.

FIG. 17 shows a cross section along the line XVII-XVII of the filter bellows of FIG. 16.

FIG. 18 is an isometric illustration of the filter bellows of FIG. 16.

FIG. 19 is an isometric illustration of a filter element according to an embodiment of the invention with a filter bellows with two oval passages.

FIG. 20 is an isometric illustration of a filter system according to an embodiment of the invention.

FIG. 21 shows a longitudinal section of the filter system according to FIG. 20 with sectioned filter element.

FIG. 22 shows details of a longitudinal section of the filter system according to FIG. 20 with a filter element sectioned at a passage of the filter bellows.

### DESCRIPTION OF PREFERRED EMBODIMENTS

In the Figures, same or same-type components are identified with same reference characters. The Figures show only examples and are not to be understood as limiting.

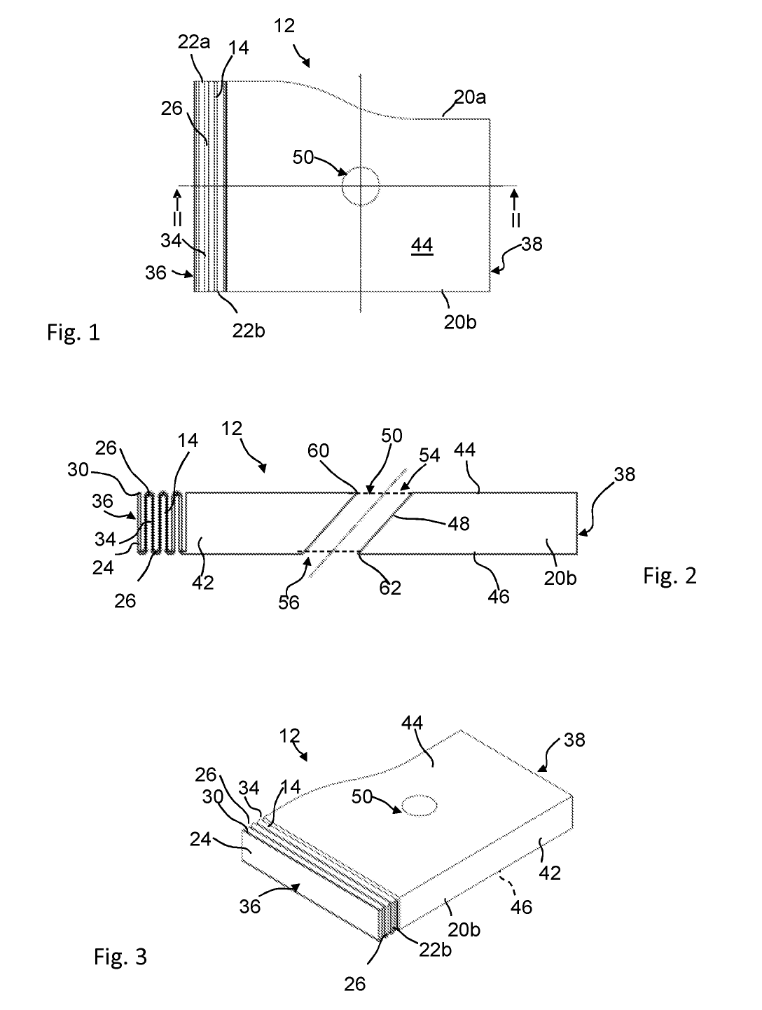

In FIGS. 1 to 3, different views of a filter bellows 12 according to an embodiment of the invention with a slanted passage 50 through the filter bellows are illustrated. FIG. 1 shows a plan view of the filter bellows 12, FIG. 2 a cross section along the line II-II, and FIG. 3 an isometric illustration. The filter bellows 12, that is configured in particular for an air filter system, comprises a filter medium 14 folded in a zigzag shape, wherein the fold edges 26 extend respectively between oppositely positioned end edge faces 20a, 20b formed of end edges 22a, 22b of the filter medium, and wherein at oppositely positioned end faces 36, 38 an end fold 24 with a fold edge 26 and an oppositely positioned free end fold rim 30 is arranged, respectively. First fold edges 26 are positioned at a raw fluid-side surface 44 that faces, in the installed state of use of the filter bellows, the raw fluid side and second fold edges 26 are positioned at an oppositely positioned clean fluid-side surface 46 that is facing the clean fluid side in the installed state of use of the filter bellows. A passage 50 is formed between the raw fluid-side surface 44 and the clean fluid-side surface 46; the passage 50 is provided with a raw fluid-side opening 60 with a raw fluid-side cross section 54 and with a clean fluid-side opening 62 with a clean fluid-side cross section 56. The extension of the passage 50 through the filter bellows 12 is such that, in a projection of the openings 60, 62 onto each other, one of the cross sections 54, 56 is arranged outside of the other one of the cross sections 56, 54. The passage 50 extends at a slant through the filter bellows 12 so that the openings 60, 62 in the projection are even positioned adjacent to each other, and the passage 50 is in the form of a round channel. The passage 50 cuts through the filter bellows 12 from the raw fluid-side surface 44 to the clean fluid-side surface 46. This means that the passage 50 in the region of its raw fluid-side opening 60 interrupts at least one raw fluid-side fold edge 26 and in the region of its clean fluid-side opening 62 at least one clean fluid-side fold edge 26. Preferably, in the region of the passage 50 and its openings 60, 62 at both ends of the passage 50, several adjacently positioned folds and thus also adjacently positioned fold edges 26 are interrupted at both ends of the passage 50.

The passage 50 can be formed, for example, by laser cutting the filter medium 14. The filter medium 14 comprises, for example, cellulose and/or is made of cellulose. The end edge face 20a is subjected to a directional change, i.e., deviates from a purely parallelepipedal shape so that the filter bellows 12 can be fitted into an installation space designed accordingly. The folds 34 of the filter medium 14 are illustrated only in one part of the filter bellows 12; the remainder of the filter bellows 12 that also comprises the filter medium 14 folded in a zigzag shape is illustrated only purely schematically.

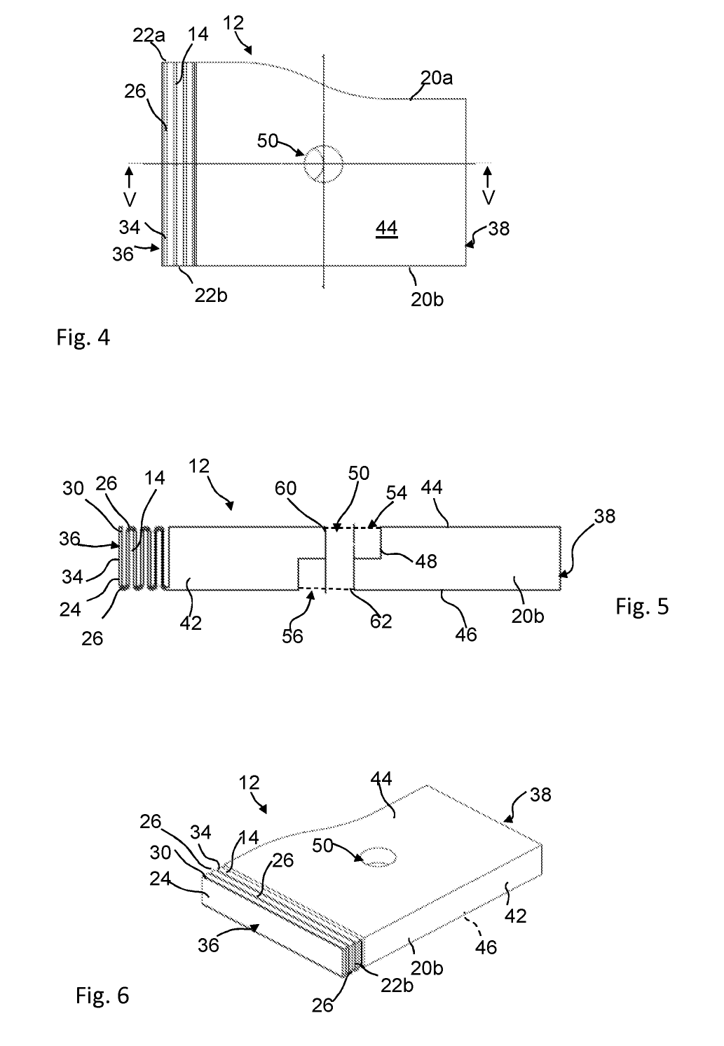

In FIGS. 4 to 6, different views of a filter bellows 12 according to another embodiment of the invention with a stepped passage 50 through the filter bellows 12 are illustrated. FIG. 4 shows a plan view of the filter bellows 12, FIG. 5 a cross section along the line V-V, and FIG. 6 an isometric illustration. The passage 50 comprises thus at least in a section thereof a stepped extension of its wall 48 in two steps. The projection of the raw fluid-side opening 60 onto the raw fluid-side surface 44 and the projection of the clean fluid-side opening 62 onto the raw fluid-side surface 44 overlap thus partially.

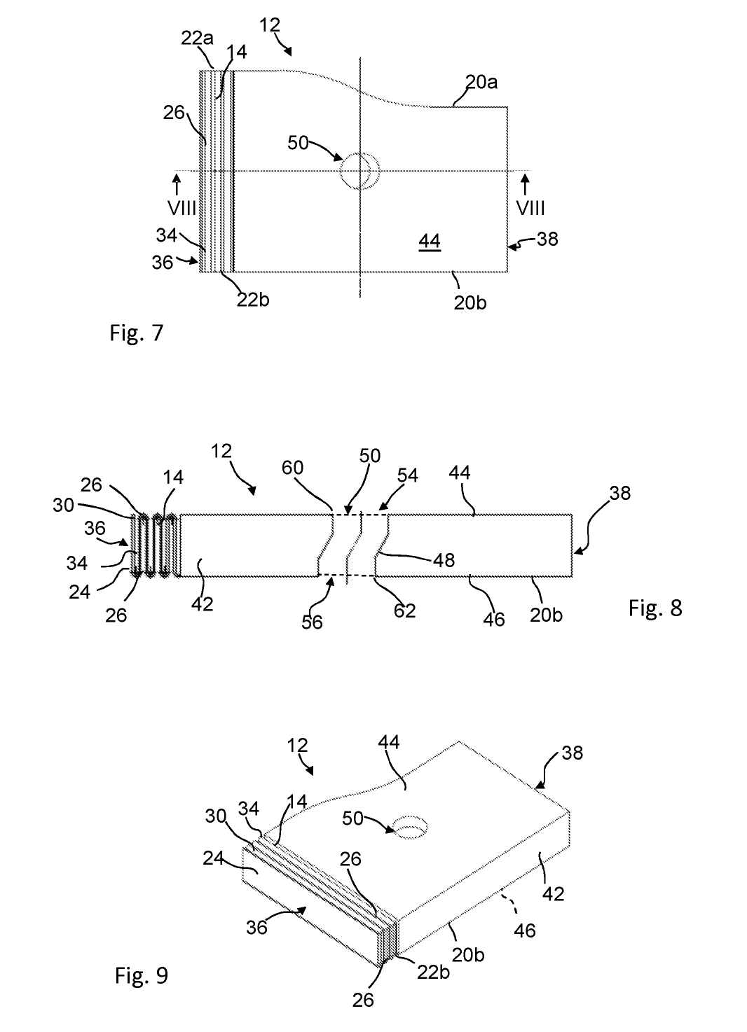

In FIGS. 7 to 9, different views of a filter bellows 12 according to a further embodiment of the invention with a passage 50 that extends in a section thereof at a slant are illustrated. FIG. 7 shows a plan view of the filter bellows 12, FIG. 8 a cross section along the line VIII-VIII, and FIG. 9 an isometric illustration. The projections of the two openings 60, 62 onto each other are positioned partially displaced adjacent to each other. The passage 50 is designed such that the raw fluid-side cross section 54 and the clean fluid-side cross section 56 are of the same size. The passage 50 extends in an inner region at a slant and connects in this way the two openings 60, 62 where the passage 50 is embodied in a first section perpendicular to the surfaces 44, 46, respectively.

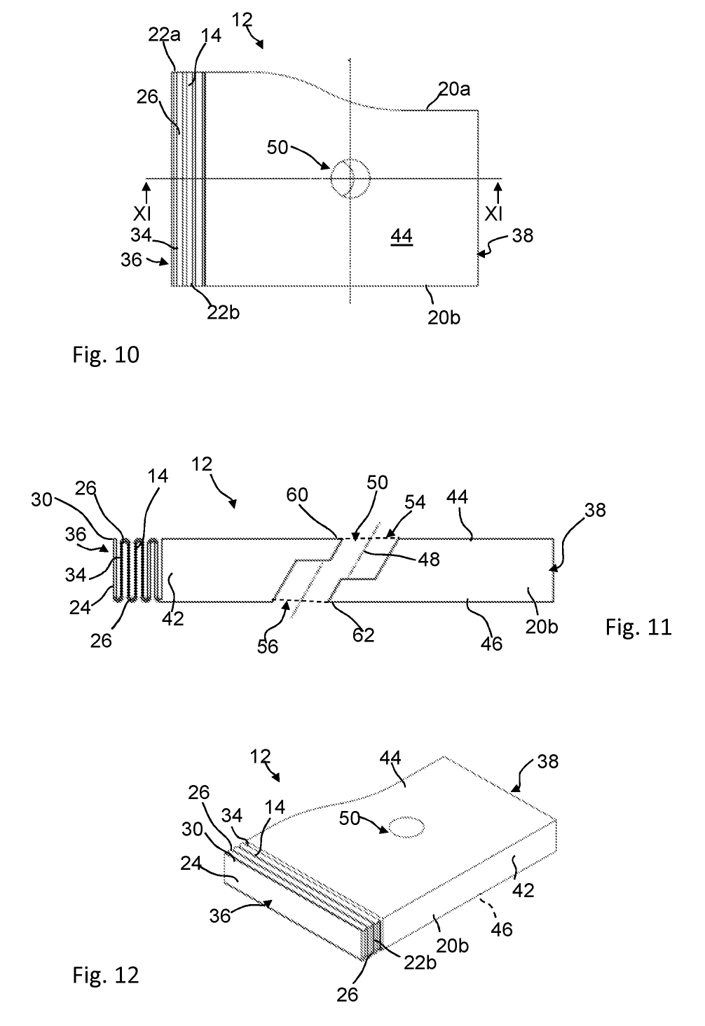

In FIGS. 10 to 12, different views of a filter bellows 12 according to a further embodiment of the invention with a passage 50 that is extending stepped and at slant are illustrated. FIG. 10 shows a plan view of the filter bellows 12, FIG. 11 a cross section along the line XI-XI, and FIG. 12 an isometric illustration. The projections of the two openings 60, 62 onto each other are positioned displaced adjacent to each other. The passage 50 is designed such that the raw fluid-side cross section 54 and the clean fluid-side cross section 56 are of the same size. The passage 50 extends in an inner region in two steps at a slant and connects thus the two openings 60, 62.

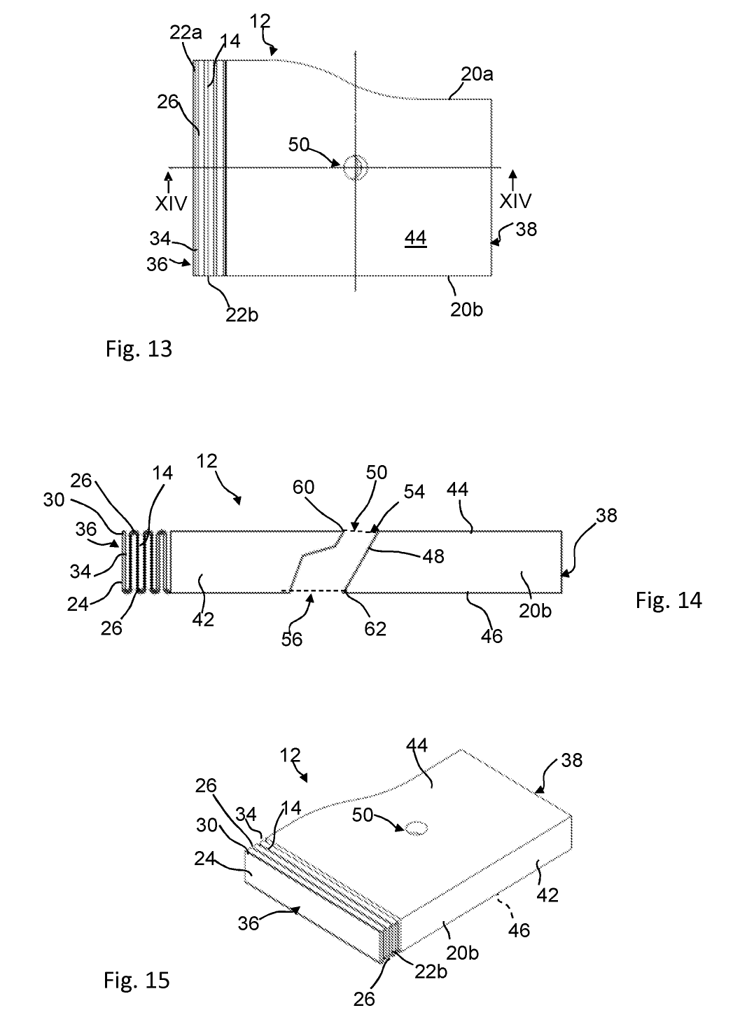

In FIGS. 13 to 15, different views of a filter bellows 12 according to a further embodiment of the invention with a passage 50 that is extending in a section thereof at a slant and conically are illustrated. FIG. 13 shows a plan view of the filter bellows 12, FIG. 14 a cross section along the line XIV-XIV, and FIG. 15 an isometric illustration. The projections of the two openings 60, 62 onto each other are positioned partially displaced adjacent to each other. The raw fluid-side opening 60 with regard to its contour is different from the contour of the clean fluid-side opening 62 and is significantly smaller in regard to diameter. The passage 50 comprises in a section thereof a slanted and conical extension between the raw fluid-side opening 60 and the clean fluid-side opening 62.

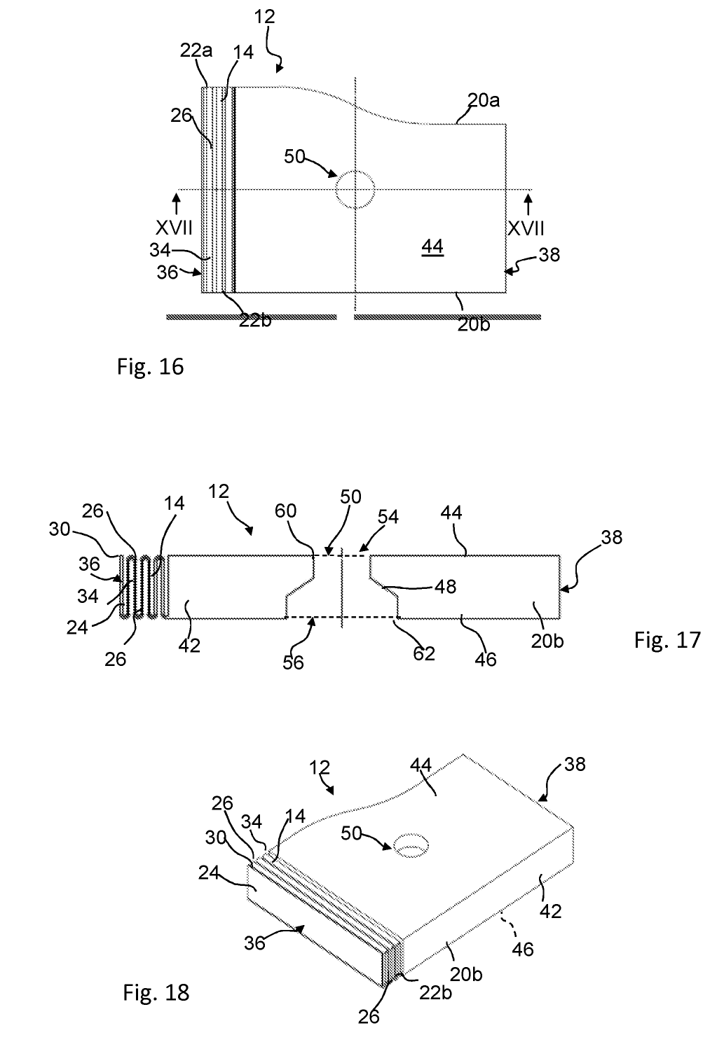

In FIGS. 16 to 18, different views of a filter bellows 12 according to a further embodiment of the invention with a passage 50 that extends in a section thereof conically are illustrated. FIG. 16 shows a plan view of the filter bellows 12, FIG. 17 a cross section along the line XVII-XVII, and FIG. 18 an isometric illustration. The projections of the two opening 60, 62 onto each other are centric. The raw fluid-side opening 60 with respect to its contour is embodied different from the contour of the clean fluid-side opening 62 and in particular embodied significantly smaller in regard to diameter so that the opening 60 in projection is lying within the interior of the projection of the opening 62. The passage 50 extends in a section thereof conically and extends perpendicular to the surfaces 44, 46 through the filter bellows 12.

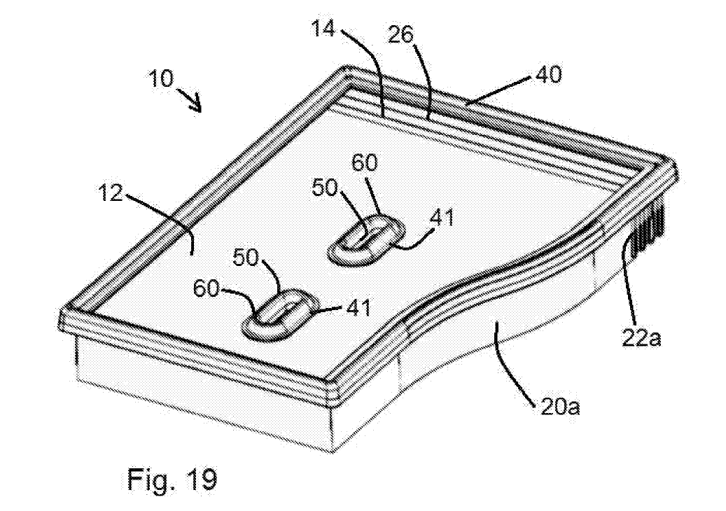

FIG. 19 shows an isometric illustration of a filter element 10 according to an embodiment of the invention comprising a filter bellows 12 with two oval passages 50. The filter element 10 for filtering a fluid comprises a filter bellows 12 of a filter medium 14 folded in a zigzag shape, wherein fold edges 26 extend between oppositely positioned end edge faces 20a, 20b formed of end edges 22a, 22b, respectively, and wherein an end fold 24 with a fold edge 26 and an oppositely positioned free end fold rim 30 is arranged at oppositely positioned end faces 36, 38, respectively, and first fold edges 26 are positioned at a raw fluid-side surface 44 in the installed state of use and second fold edges 26 at an oppositely positioned clean fluid-side surface 46 in the installed state of use. Two passages 50 are formed between the raw fluid-side surface 44 and the clean fluid-side surface 46 with a raw fluid side opening 60 with a raw fluid-side cross section 54 and a clean fluid-side opening 62 (not visible) with a clean fluid-side cross section 56, respectively, wherein in a projection of the openings 60, 62 onto each other at least one of the cross sections 54, 56 is at least with sections thereof arranged outside of the other one of the cross sections 56, 54. The filter bellows 12 comprises a circumferentially extending seal 40 at end edges 22a, 22b and at end fold rims 30 of the raw fluid-side surface 44 as well as a circumferentially extending seal 41 at the raw fluid-side opening 60 of the passages 50. The seals 40, 41 are foamed onto the filter bellows 12 and are comprised, for example, of PUR foam. The end edge face 20a is subjected to a directional change so that the filter element 10 can be fitted into a correspondingly designed installation space. The filter element 10 can be used, for example, as a flat air filter, in particular of an internal combustion engine, in particular of a motor vehicle.

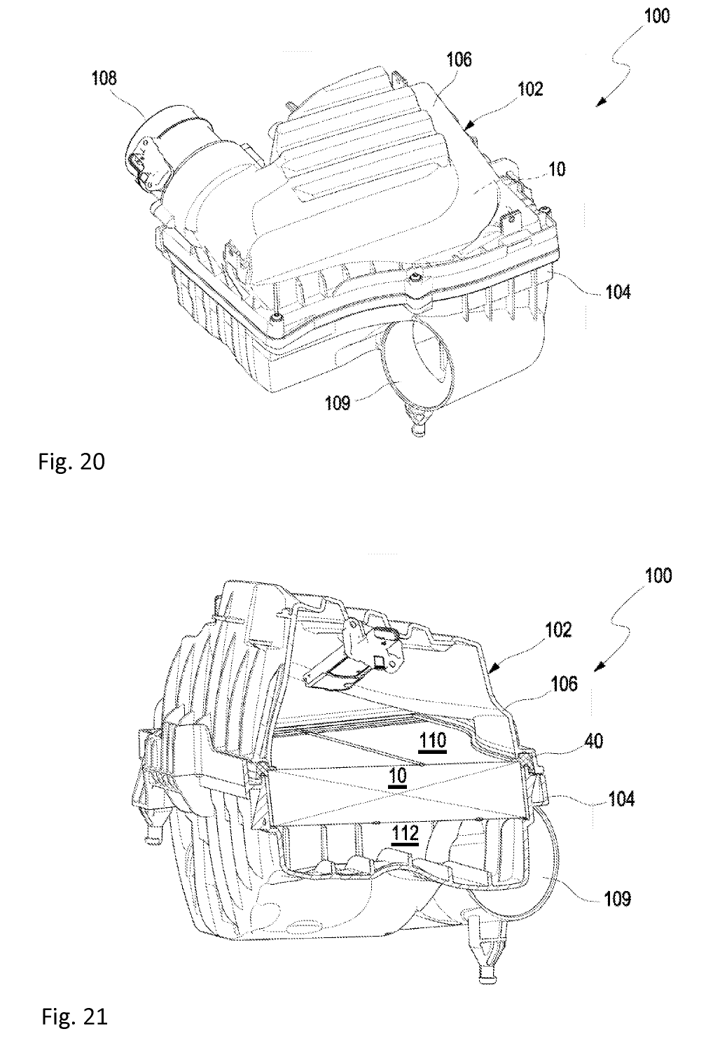

FIG. 20 shows an isometric illustration of a filter system 100 according to an embodiment of the invention. The filter system 100 comprises a filter element 10 in a filter housing 102 that is comprised of a housing bottom part 104 and a housing top part 106 which are connected fluid-tightly to each other, for example, screwed together. The filter housing 102 comprises an inlet 108 and an outlet 109 for the fluid to be filtered.

FIG. 21 shows in this context a longitudinal section of the filter system 100 according to FIG. 20 with sectioned filter element 10. The filter element 10 is arranged exchangeably in the filter housing 102 that comprises the housing bottom part 104 and the housing top part 106 which, by means of a screw connection, are detachably but fluid-tightly connected to each other. The filter element 100 fluid-tightly separates in this context the raw fluid side 110 from the clean fluid side 112 of the filter system 100. The filter element 10 is arranged with the circumferentially extending seal 40 at the separation location between housing bottom part 104 and housing top part 106 of the filter housing 102 and is seated with the seal 40 on the housing bottom part 104. In this way, with the circumferentially extending seal 40 of the filter element 10 also the filter housing 102 can be sealed upon placement of the housing top part 106 onto the housing bottom part 104.

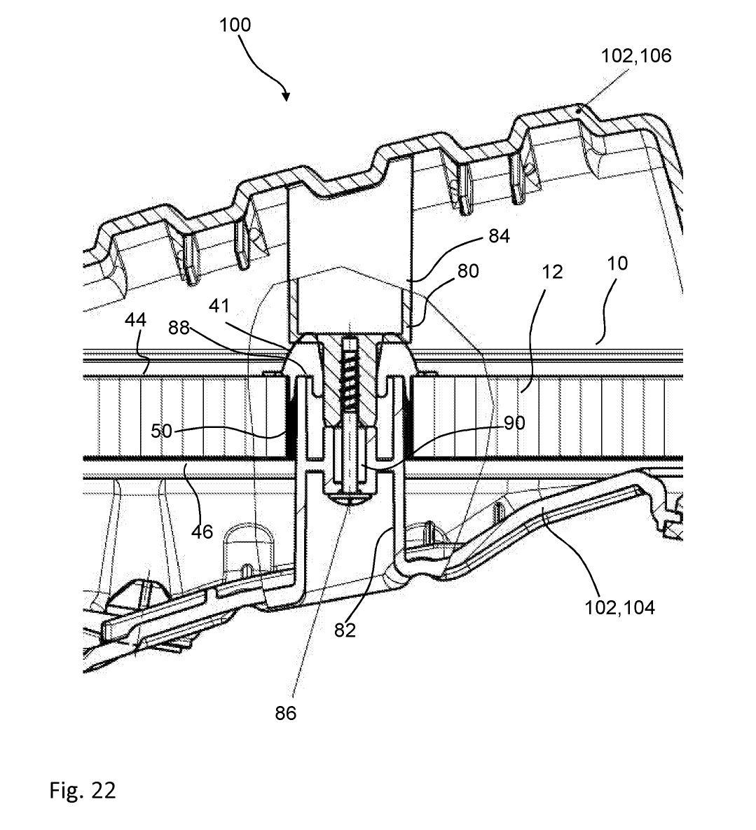

In FIG. 22, details of a longitudinal section of the filter system 100 according to FIG. 20 with a filter element 10 sectioned at a passage 50 of the filter bellows 12 are illustrated. A reinforcement center support 80 which is supported at the housing bottom part 104 and housing top part 106 is arranged in the passage 50 when the filter element is installed. For reinforcement, the filter housing 102 comprises at its center point the reinforcement center support 80 which is comprised of a hollow socket 82 fastened to the housing bottom part 104 and a threaded socket 84 which is fastened to the housing top part 106. The sockets 82, 84 are connected to each are by a connecting screw 86 after the housing top part 106 has been placed onto the housing bottom part 104. In this context, the reinforcement center support 80 extends through a passage 50 provided in the filter bellows 12 which is sealed by a seal 41 relative to the reinforcement center support 80. By means of the seal 41, a consequent sealing action between raw fluid side 110 and clean fluid side 112 is provided also in the region of the passage 50.

The construction of the reinforcement center support 80, comprised of hollow socket 82 and threaded socket 84, can be seen in FIG. 22. These two components form a receptacle 88 for the seal 41. By tightening the connecting screw 86, which is inserted from the exterior into the hollow socket 82 and subsequently is screwed into the threaded socket 84, the seal 41 is deformed in the receptacle 88 so that the sealing action is realized. For a subsequent demounting of the filter element 10, the hollow socket 82 is thus provided with a captive securing action 90 in which the screw remains after unscrewing from the threaded socket 84.

What is claimed is:

1. A filter bellows comprising a filter medium folded in a zigzag shape, the filter bellows comprising oppositely positioned end edge faces formed of end edges of the filter medium and further comprising first and second fold edges extending between the oppositely positioned end edge faces, the filter bellows further comprising oppositely positioned end faces extending transversely to the end edge faces, wherein the end faces each comprise an end fold comprising a fold edge and a free end fold rim positioned opposite the fold edge of the end fold, wherein the filter bellows, in a state of use, comprises a raw fluid-side surface and a clean fluid-side surface opposite the raw fluid-side surface, wherein the first fold edges are positioned at the raw fluid-side surface and the second fold edges are positioned at the clean fluid-side surface, wherein the filter bellows comprises a passage extending between the raw fluid-side surface and the clean fluid-side surface, wherein the passage comprises a first opening, arranged at the raw fluid-side surface and comprising a first cross section, and further comprises a second opening, arranged at the clean fluid-side surface and comprising a second cross section, wherein, in a projection of the first and second openings onto each other, one of the first and second cross sections, at least with sections thereof, is arranged outside of the other one of the first and second cross sections.

2. The filter bellows according to claim 1, wherein the first opening comprises a contour that is different from a contour of the second opening.

3. The filter bellows according to claim 1, wherein the first and second fold edges are straight.

4. The filter bellows according to claim 1, wherein the passage interrupts at least one of the first fold edges at the first opening and further interrupts at least one of the second fold edges at the second opening.

5. The filter bellows according to claim 1, wherein the passage comprises, at least in a section thereof, a conical extension between the first opening and the second opening.

6. The filter bellows according to claim 1, wherein the passage comprises a wall comprising, at least in a section thereof, a stepped extension.

7. The filter bellows according to claim 1, wherein at least one of the end edge faces comprises a directional change.

8. The filter bellows according to claim 1, wherein at least one of the end faces comprises a directional change.

9. The filter bellows according to claim 1, wherein at least one of the end faces comprises a directional change and wherein at least one of the end edge faces comprises a directional change.

10. The filter bellows according to claim 1, wherein the passage is formed by laser cutting the filter medium.

11. The filter bellows according to claim 1, wherein the filter medium comprises cellulose.

12. The filter bellows according to claim 11, wherein the filter medium is made of cellulose.

13. A filter element for filtering a fluid, the filter element comprising a filter bellows, the filter bellows comprising a filter medium folded in a zigzag shape, the filter bellows comprising oppositely positioned end edge faces formed of end edges of the filter medium and further comprising first and second fold edges extending between the oppositely positioned end edge faces, the filter bellows further comprising oppositely positioned end faces extending transversely to the end edge faces, wherein the end faces each comprise an end fold comprising a fold edge and a free end fold rim positioned opposite the fold edge of the end fold, wherein the filter bellows, in a state of use, comprises a raw fluid-side surface and a clean fluid-side surface opposite the raw fluid-side surface, wherein the first fold edges are positioned at the raw fluid-side surface and the second fold edges are positioned at the clean fluid-side surface, wherein the filter bellows comprises a passage extending between the raw fluid-side surface and the clean fluid-side surface, wherein the passage comprises a first opening, arranged at the raw fluid-side surface and comprising a first cross section, and further comprises a second opening, arranged at the clean fluid-side surface and comprising a second cross section, wherein, in a projection of the first and second openings onto each other, one of the first and second cross sections, at least with sections thereof, is arranged outside of the other one of the first and second cross sections.

14. The filter element according to claim 13, wherein the filter bellows comprises a first circumferentially extending seal arranged at the end edges and the end fold rims at the raw fluid-side surface and/or at the clean fluid-side surface and further comprises a second circumferentially extending seal at the first opening and/or at the second opening of the passage.

15. The filter element according to claim 14, wherein the first and second circumferentially extending seals are foamed onto the filter bellows.

16. The filter element according to claim 13, wherein at least one of the end edge faces comprises a directional change.

17. The filter element according to claim 13, wherein at least one of the end faces comprises a directional change.

18. The filter element according to claim 13, wherein at least one of the end faces comprises a directional change and wherein at least one of the end edge faces comprises a directional change.

19. The filter element according to claim 13 embodied as a flat air filter.

20. A filter system comprising:
a filter housing comprising at least a housing bottom part and a housing top part, wherein the housing bottom part and the housing top part are detachably and fluid-tightly connected to each other;
a filter element exchangeably arranged in the filter housing, wherein the filter element fluid-tightly separates a raw fluid side from a clean fluid side in the filter housing;
the filter element comprising a filter bellows;
the filter bellows comprising a filter medium folded in a zigzag shape;
the filter bellows comprising oppositely positioned end edge faces formed of end edges of the filter medium and further comprising first and second fold edges extending between the oppositely positioned end edge faces, the filter bellows further comprising oppositely positioned end faces extending transversely to the end edge faces, wherein the end faces each comprise an end fold comprising a fold edge and a free end fold rim positioned opposite the fold edge of the end fold, wherein the filter bellows, in a state of use, comprises a raw fluid-side surface and a clean fluid-side surface opposite the raw fluid-side surface, wherein the first fold edges are positioned at the raw fluid-side surface and the second fold edges are positioned at the clean fluid-side surface, wherein the filter bellows comprises a passage extending between the raw fluid-side surface and the clean fluid-side surface, wherein the passage comprises a first opening, arranged at the raw fluid-side surface and comprising a first cross section, and further comprises a second opening, arranged at the clean fluid-side surface and comprising a second cross section, wherein, in a projection of the first and second openings onto each other, one of the first and second cross sections, at least with sections thereof, is arranged outside of the other one of the first and second cross sections.

21. The filter system according to claim 20, wherein the filter housing further comprises a reinforcement center support supported at the housing bottom part and/or at the housing top part, wherein the reinforcement center support is arranged in the passage when the filter element is installed in the filter housing.

22. The filter system according to claim 21, wherein the passage is embodied as a clean air outlet of the filter system.
